(19) United States
(12) Patent Application Publication
(10) Pub. No.: US 2009/0024490 A1
(43) Pub. Date: Jan. 22, 2009

(54) System and method for web to package printing

(76) Inventor: Edward W. Satterfield, Chevy Chase, MD (US)

Correspondence Address: MILES & STOCKBRIDGE PC, 1751 PINNACLE DRIVE, SUITE 500, MCLEAN, VA, 22102-3833, US

(21) Appl. No.: 12/216,964

(22) Filed: Jul. 14, 2008

Related U.S. Application Data
(60) Provisional application No. 60/950,620, filed on Jul. 19, 2007.

(51) Int. Cl. G06Q 30/00

(52) U.S. Cl. 705/27

(57) ABSTRACT

A beginning to end solution is provided for ordering package printing on-line. A system and method for web to package printing is disclosed providing users online selecting, designing and proofing of a desired product in a three dimensional view.

### CROSS REFERENCE

This application claims the benefit of U.S. Provisional Application No. 60/950,620 filed Jul. 19, 2007.

### FIELD OF THE INVENTION

The present invention relates to a system and method for web to package printing, specifically a means for a complete web to package printing solution for business to business (B2B) and customer to business (C2B) involving online selecting, designing, and virtual print quality online proofing of the product in three dimensional view including finishing techniques available is disclosed herein. Currently the World Wide Web and package printing arenas have yet to merge. This invention allows anyone access to the web to select, design, proof virtual print quality, cost, and order packaging with the addition of three-dimensional tools.

### BACKGROUND OF THE INVENTION

A complete web to package printing solution is needed to advance the package printing business. Currently the web to print solutions have worked with and been designed in a two-dimensional, paint the canvas environment offering a two dimensional or crude three-dimensional preview. These solutions hold the user to a limited field of view of the final production printed piece without any finishing options including but not limited to foil stamping, embossing, debossing, laminating, and UV coating. With the present invention the user is able to complete the pre-press process all via the web using the additional tools to view and work with a true three-dimensional model of the product. The user is able to view things such as color breaks around the object, the difference between lamination finishes, different types of foil stamping, how an embossing or debossing will look, or a flood UV or spot UV coating and how these will affect the printed piece. The disclosed system and method gives the user a real-time environment showing the effects of different finishing techniques and allowing key choices to be made in the development process.

### SUMMARY OF THE INVENTION

It is an object of the invention to allow a complete beginning to end solution for ordering package printing online.

It is a further object of the invention to allow the user a real-time three-dimensional (3D) environment by which one can select, design, proof, cost, and order package printing online.

It is a further object of the invention to give the user a true to life visual representation of the package printing, finishing, and assembly.

It is a further object of the invention to use the 3D environment for proofing to reduce the need for a ‘hard’ copy.

It is a further object of the invention to shorten the time needed to get package printing to the press by streamlining the pre-press process.

It is a further object of the invention to make package printing available to anyone with a connection to the web.

It is a further object of the invention to simplify the package printing process.

There has thus been outlined, rather broadly, the more important features of the invention in order that the detailed description thereof that follows may be better understood, and in order that the present contribution to the art may be better appreciated. There are, of course, additional features of the invention that will be described further hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced or carried out in various ways. Also, it is to be understood that the phraseology and terminology employed herein are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that equivalent constructions insofar as they do not depart from the spirit and scope of the present invention, are included in the present invention.

For a better understanding of the invention, its operating advantages and the specific objects attained by its uses, reference should be had to the accompanying drawings and descriptive matter, which illustrate embodiments of the invention.

### BRIEF DESCRIPTION OF THE DRAWINGS

FIG. 1 illustrates a layout view of an unassembled package, a folding sequence view and fully assembled view of a package.

FIG. 2 illustrates a sample webpage with product overview.

FIG. 3 illustrates a product breakdown providing further details within a product category.

FIG. 4 illustrates a final product selection with specifics of the product.

FIG. 5 illustrates a login—capture data page.

FIG. 6 illustrates resizing options for final product selection.

FIG. 7 illustrates graphic art for a packaging decision page.

FIG. 8 illustrates a dieline download and 3D virtual proof of the selected product.

FIG. 9 illustrates an artwork upload page.

FIG. 10 illustrates a second artwork upload processing page.

FIG. 11 illustrates a proofing area with 2D view, 3D view, and finishing options.

FIG. 12 is another illustration of a proofing page showing different options.

FIG. 13 is an illustration of a proofing page from one of the graphic art templates showing different options.

FIG. 14 illustrates an example job overview giving product specifications.

FIG. 15 illustrates a flowchart of the invention.

### DETAILED DESCRIPTION OF THE INVENTION

The present invention provides a complete method of web to package printing involving the use of 3D views and tools allowing a virtual proof to be checked and approved. More particularly, the invention allows specialty-finishing techniques to be viewed on a virtual printed package. The web browser interface provides the user all the options necessary including but not limited to selecting, designing, proofing virtual print quality and finishing, costing, and ordering package printing via the Internet. The invention can streamline the package printing process giving the user an interface by which all pre-press is completed.

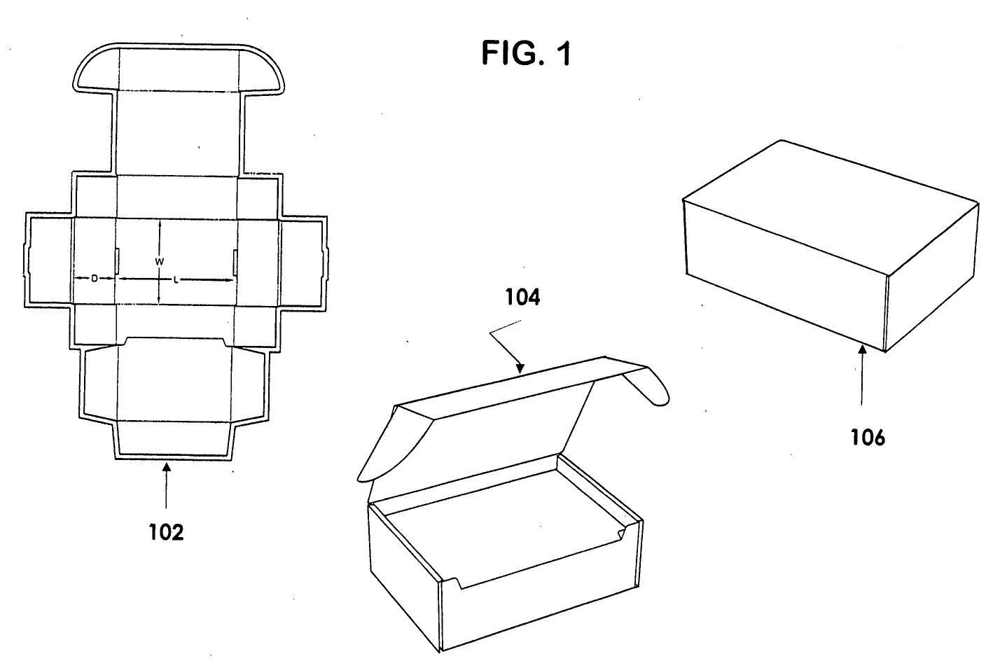

FIG. 1 illustrates a layout view of a dieline with graphics including unassembled package 102, assembled package 104 showing folding sequence view and assembled and folded package 106.

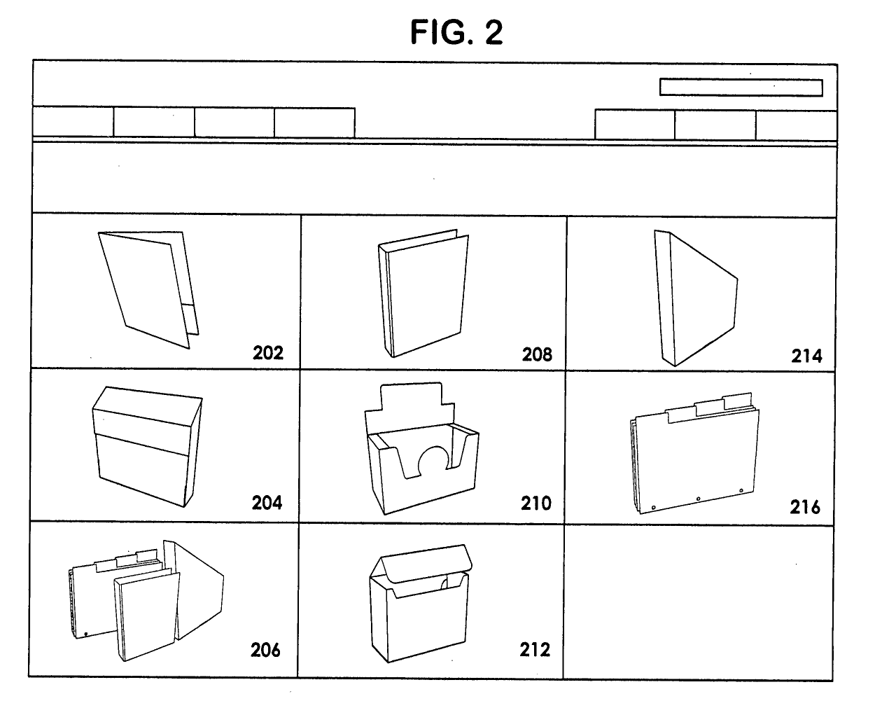

FIG. 2 illustrates a sample webpage with product overview. Folder(s) 202 can be, for example, one pocket, two pocket, or expansion/gusset. Folder(s) 202 can comprise a pocket having a predefined capacity. Folder(s) 202 can be specially designed from an array of specialty selections. Container(s) 204 can be, for example, expandable totes or rigid boxes; can include Velcro closures; or elastic loop closures; and can be versatile and/or expandable. Container(s) 204 can be specially designed from an array of specialty selections. Grouped product(s) 206 can be, coordinated products, style guides, new member kits, tradeshow kits, and the like. Grouped product(s) 206 can be specially designed from an array of specialty selections. Binder(s) 208 can include, for example, turned edge, Euro-hinge, media slits, colored metals and 0.5 to 3 inch capacity. Binder(s) 208 can be specially designed from an array of specialty selections. Point of Purchase(s) 210 can include, for example, Point of Purchase easels, countertop displays, pegboard packaging, folding cartons, and signs. Point of Purchase(s) 210 can be specially designed from an array of specialty selections. Promotional Package(s) 212 can include, for example direct mail, promotional campaigns, new product introductions, special events and give-a-ways. Promotional Package(s) 212 can be specially designed from an array of specialty selections. Turned Edge Product(s) 214 can include slipcases, slashboxes, case box, presentation folder, set-up boxes, and the like. Turned Edge Product(s) 214 can be specially designed from an array of specialty selections. Tabs and Indexes 216 can include legal, medical, banking, real estate, calendar and the like. Tabs and Indexes 216 can be specially designed from an array of specialty selections.

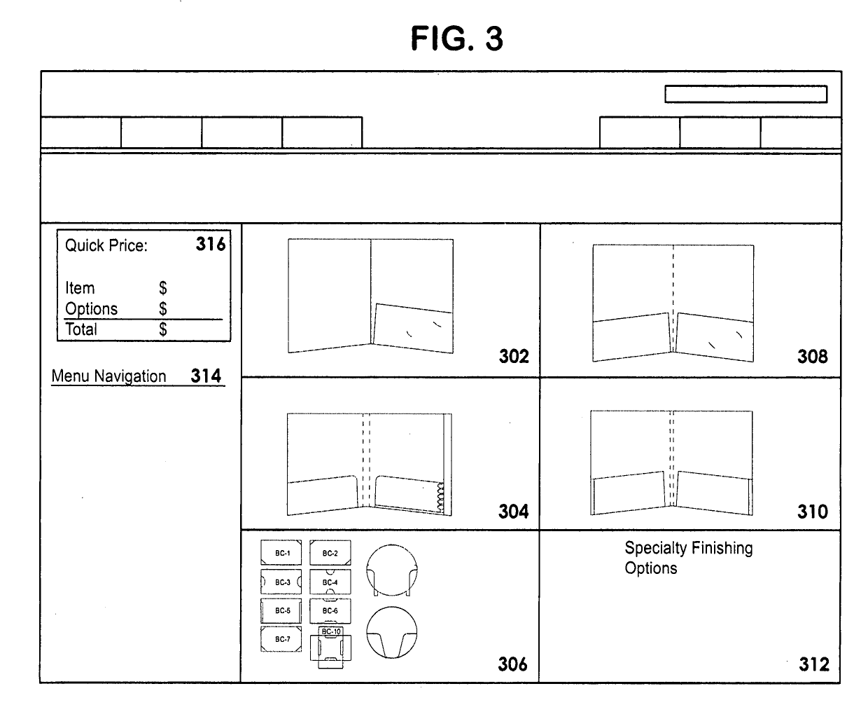

FIG. 3 illustrates an exemplary product breakdown providing further details within a product category. First folder 302 can include, for example, a one-pocket folder. Exemplary options could include: 10 point stock, print on one side, 9 inch by 12 inch dimension, 10-sheet capacity, and 4 inch pocket. Finishing options can be designated by user, or selected from a list of options defined in library of graphics 704 or online design area 706. Second folder 304 can include, for example, an expansion folder with options including but not limited to: 10 point stock, print on one side, 9¼ inch by 11¾ inch dimension, 50-sheet capacity, and 4½ inch pocket. Finishing options can be designated by user, or selected from a list of options defined in the Library of Graphics 704 or the Online Design Area 706. Alternative options 306 can include, for example, business card slits, CD/DVD holders, rolodex holders, 12 point stock, 14 point stock, 18 point stock, and the like. Third folder 308 can include, for example, a two-pocket folder. Exemplary options could include: 10 point stock, print on one side, 9 inch by 12 inch dimension, 20-sheet capacity, and 4 inch pocket. Finishing options can be designated by user, or selected from a list of options defined in library of graphics 704 or online design area 706. Fourth folder 310 can include, for example, a capacity folder. Exemplary options could include: 10 point stock, print on one side, 9½ inch by 12 inch dimension, 40-sheet capacity, and 4 inch pocket. Finishing options can be designated by user, or selected from a list of options defined in library of graphics 704 or online design area 706. Specialty finishing options 312 can include, for example: film laminating, such as glossy, dull, or satin; ultra violet (UV) coating, such as flood or spot; die-cut windows, foil stamping, with choice of foils; and/or embossing and debossing. Menu navigation 314 can include, for example, a listing of available web to package printing products for ease of navigation within system. Quick price 316 includes a pricing guide for the product selection to this point in the ordering process.

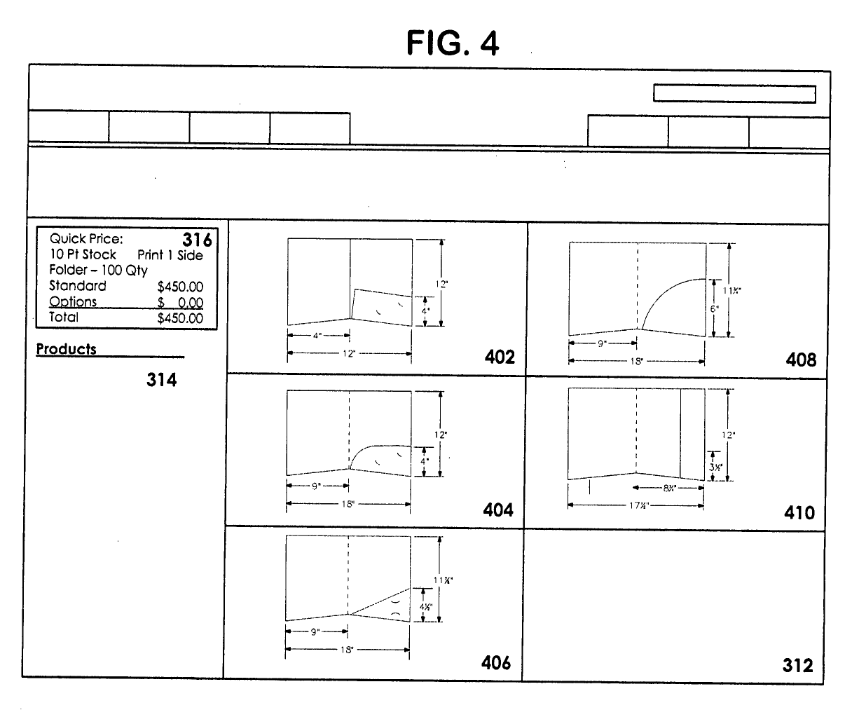

FIG. 4 illustrates a final product selection with specifics of the product. Fifth folder 402 can include, for example, a standard one-pocket folder. Exemplary options could include: 10 point stock, print on one side, 9 inch by 12 inch dimension, 10-sheet capacity, and 4 inch pocket. Finishing options can be designated by user, or selected from a list of options defined in library of graphics 704 or online design area 706. Sixth folder 404 can include, for example, a curved one-pocket folder. Exemplary options could include: 10 point stock, print on one side, 9 inch by 12 inch dimension, 20-sheet capacity, and 4½ inch pocket. Finishing options can be designated by user, or selected from a list of options defined in library of graphics 704 or online design area 706. Seventh folder 406 can include, for example, a diagonal one-pocket folder. Exemplary options could include: 10 point stock, print on one side, 9¼ inch by 11¾ inch dimension, 20-sheet capacity, and 4½ inch pocket. Finishing options can be designated by user, or selected from a list of options defined in library of graphics 704 or online design area 706. Eighth folder 408 can include, for example, a rounded one-pocket folder. Exemplary options could include: 10 point stock, print on one side, 9 inch by 12 inch dimension, 20-sheet capacity, and 4 inch pocket. Finishing options can be designated by user, or selected from a list of options defined in library of graphics 704 or online design area 706. Ninth folder 410 can include, for example, a vertical one-pocket folder. Exemplary options could include: 10 point stock, print on one side, 8¾ inch by 12 inch dimension, 10-sheet capacity, and 4 inch pocket. Finishing options can be designated by user, or selected from a list of options defined in library of graphics 704 or online design area 706. Specialty finishing options 312 can include, for example: film laminating, such as glossy, dull, or satin; ultra violet (UV) coating, such as flood or spot; die-cut windows, foil stamping, with choice of foils; and/or embossing and debossing. Menu navigation 314 includes, for example, a listing of available web to package printing products for ease navigation to other areas. Quick price 316 includes a pricing guide for the product selection to this point in the ordering process.

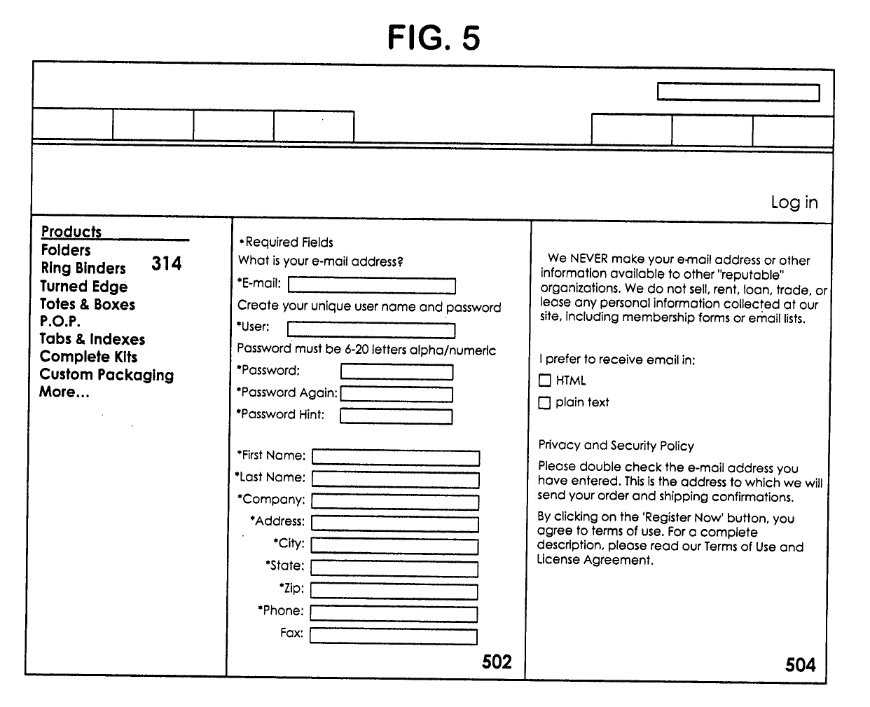

FIG. 5 illustrates a login—capture data page. Form field 502 for example, includes data fields to identify a user. Text area 504 for example, can include but is not limited to privacy, security policies, preferred contact method, and/or a submit button.

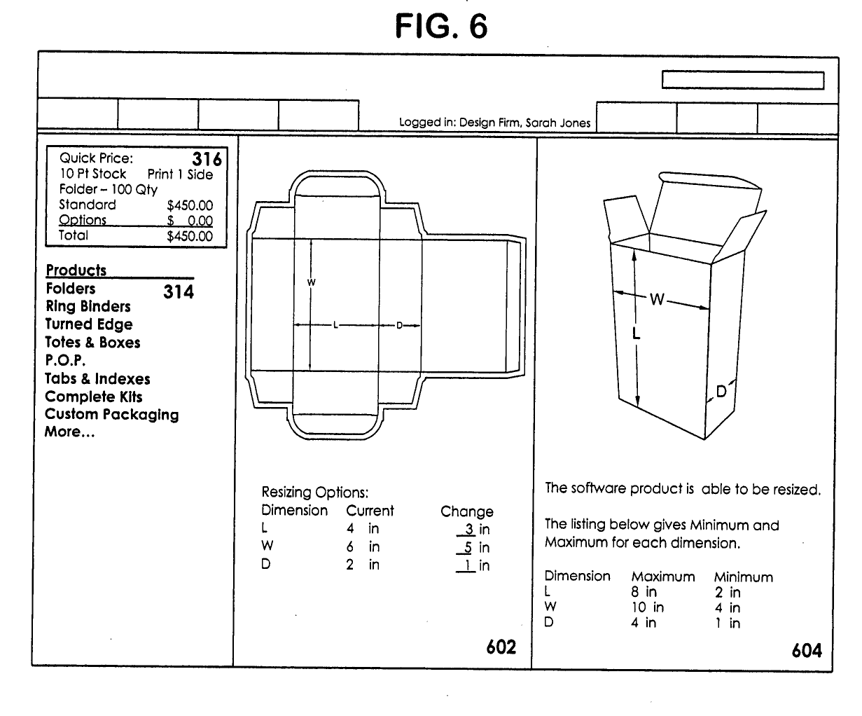

FIG. 6 illustrates resizing options for the final product selection, if available. Standard product selected 602 for example, can include the dieline with default dimensions with an area to change dimensions. Resizing options 604 for example, can include verbiage as to the limits of resizing available for the selected product and warnings if any inputted dimension exceeds limits.

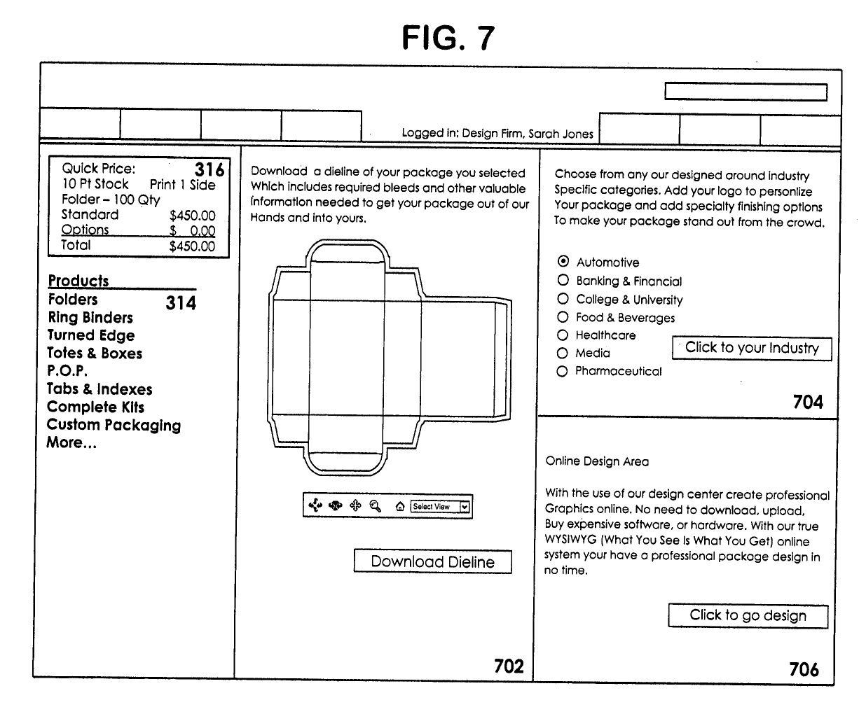

FIG. 7 illustrates a graphic art for packaging decision page to aid the user in selecting either to use a library of supplied graphics, an on site graphic design area with tools to create graphics, or to download a dieline for the user to create their own graphics to be applied to the chosen package. Dieline download 702 for example, can include verbiage discussing what the dielines include, a picture of dieline, viewing options to examine the dieline in detail including but not limited to, zoom, rotate, pan, and any other tools necessary, and selection option to go to the download page. Library of graphics 704 for example, can include verbiage about the use of the library, can be broken down into categories including but not limited to automotive, banking & financial, college & university, food & beverages, healthcare, media, pharmaceutical, publishing, and sports. Online design area 706 for example, can include verbiage about available online tools to create graphics online in a WYSIWYG (What You See Is What You Get) environment. Menu navigation 314 includes, for example, a listing of available web to package printing products for ease navigation to other areas. Quick price 316 includes a pricing guide for the product selection to this point in the ordering process.

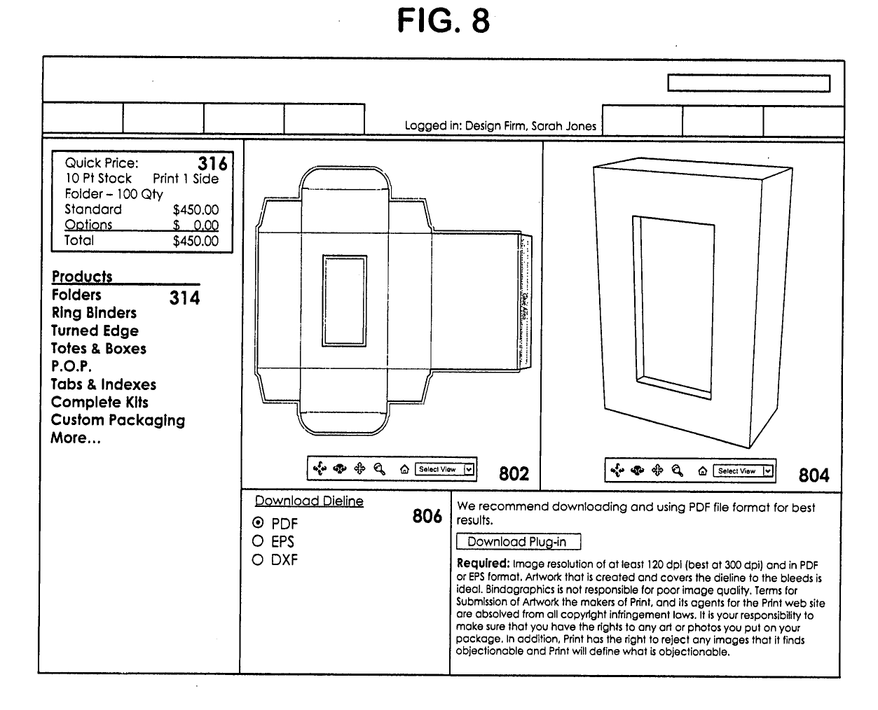

FIG. 8 illustrates a dieline download and 3D virtual proof of the selected product. Dieline artwork 802 can include, for example, but is not limited to a layout of the package showing lines pertaining to the different rule or guides necessary to produce the package in production. Viewing options to examine the package in detail include but are not limited to, zoom, rotate, pan, and any other tools necessary. 3D proof 804 can include, for example, but is not limited to a virtual 3D product. Viewing options to examine the package in detail include but are not limited to: zoom, rotate, pan, folding sequence, order of assembly, and any other tools necessary to proof the package. Download options 806 can include, for example, file formats to which the user is going to download, recommended format, and required specifications for the artwork to be used. File formats can include for example: PDF, EPS, DXF, and the like. Menu navigation 314 includes, for example, a listing of available web to package printing products for ease navigation to other areas. Quick price 316 includes a pricing guide for the product selection to this point in the ordering process.

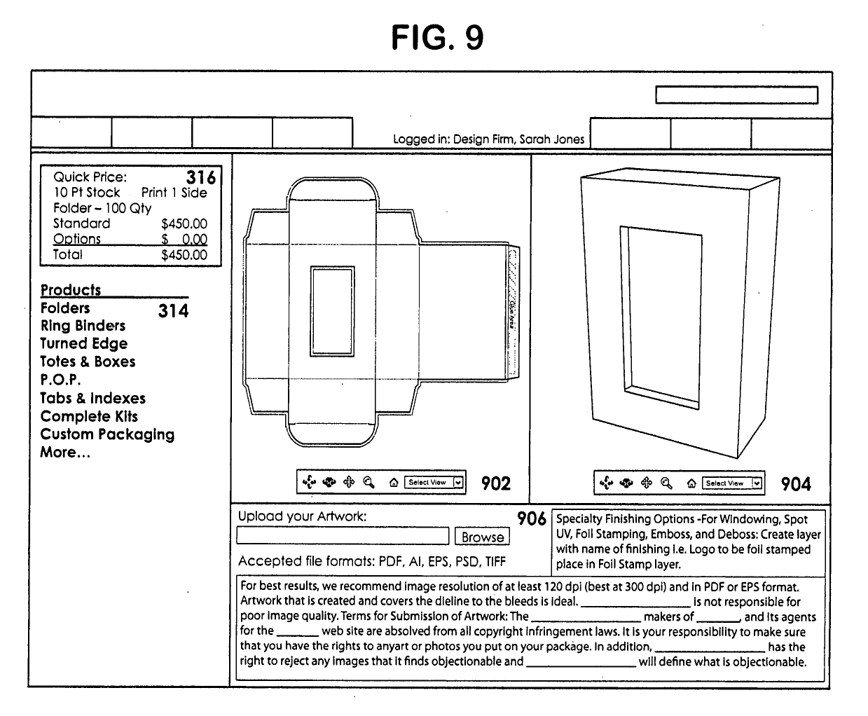

FIG. 9 illustrates an artwork upload page. Second dieline artwork 902 can include, for example, but is not limited to a layout of the package showing lines pertaining to the different rule or guides necessary to produce the package in production. Viewing options to examine the package in detail including zoom, rotate, pan, and any other tools necessary. Second 3D Proof 904 can include, for example, but is not limited to a virtual 3D product. Viewing options to examine the package in detail including: zoom, rotate, pan, folding sequence, order of assembly, and any other tools necessary to proof the package. Upload artwork 906 can include, for example, acceptable file formats to which the user is going to upload; a browse feature to allow the user to locate the artwork to apply; specialty finishing options outlined to allow the user to make these options available; and required specifications for the artwork to be uploaded. Acceptable file format can include PDF, AI, EPS, PSD, TIFF, and the like. Menu navigation 314 includes, for example, a listing of available web to package printing products for ease navigation to other areas. Quick Price 316 includes a pricing guide for the product selection to this point in the ordering process.

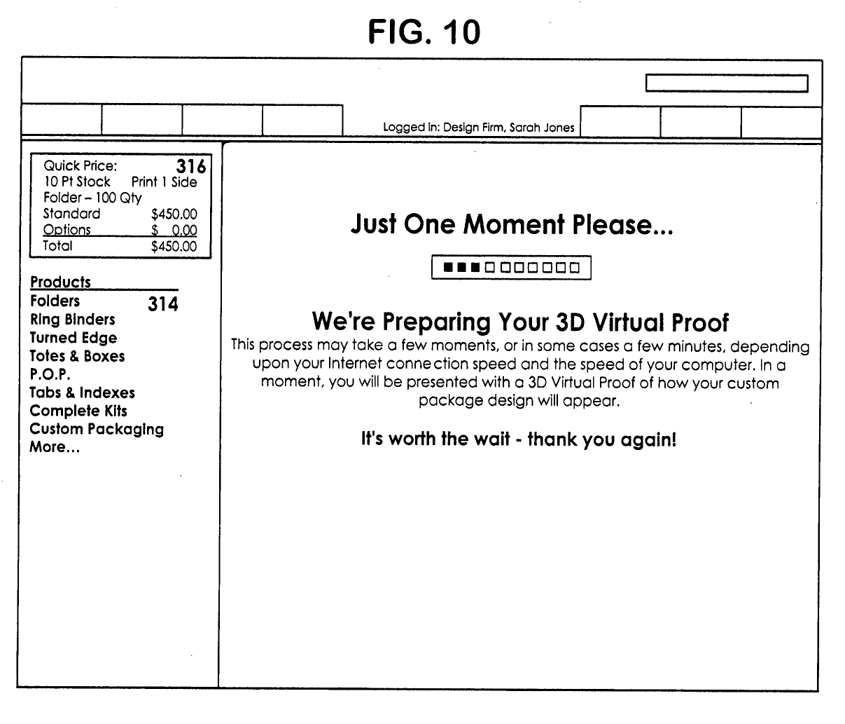

FIG. 10 illustrates an artwork upload processing page with a status bar indicating the remaining time until the artwork is uploaded and processed. This page can also inform the user as to the reason for any delay and what to expect once the process is completed.

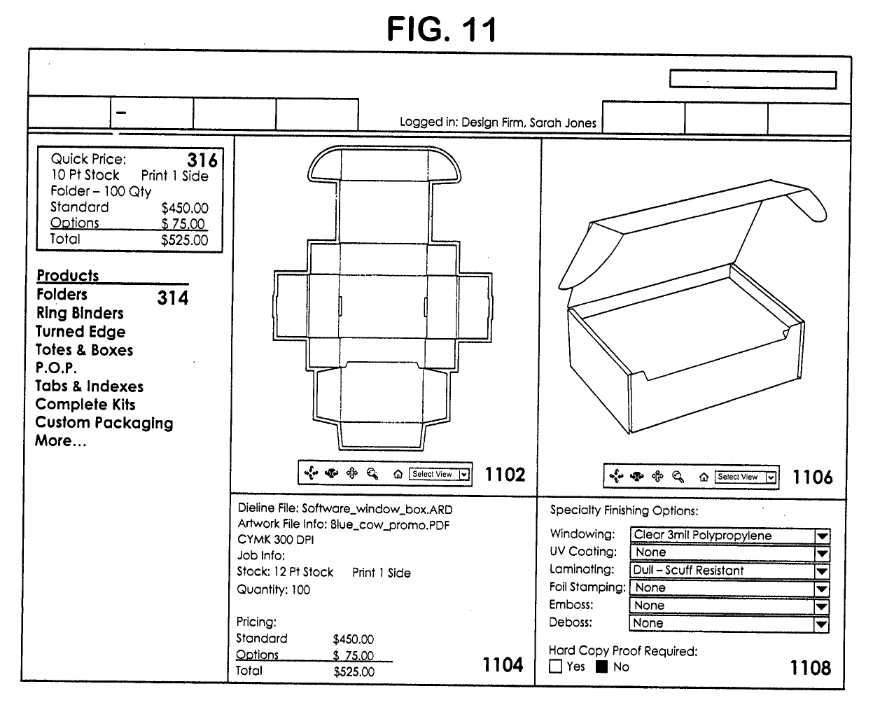

FIG. 11 illustrates a proofing area with 2D view, 3D view, and finishing options. Dieline with art 1102 includes, but is not limited to a 2D layout with viewing options to examine the package in detail. Job details 1104 gives specifics and options of the job pertaining to the die, artwork, and job. 3D Proof 1106 can include, for example, but is not limited to a virtual 3D product. Viewing options to examine the package in detail including: zoom, rotate, pan, folding sequence, order of assembly, and any other tools necessary to proof the 3D virtual package. This virtual 3D proof is updated in real-time showing the options selected in specialty finishing options 1108. Specialty finishing options 1108 can include, for example, options for windowing, UV coating, laminating, foil stamping, embossing, and debossing. This area can include option for a hard copy proof should one be desired. Menu navigation 314 can include, for example, a listing of available web to package printing products for ease navigation to other areas. Quick price 316 can include, for example a pricing guide for the product selection to this point in the ordering process.

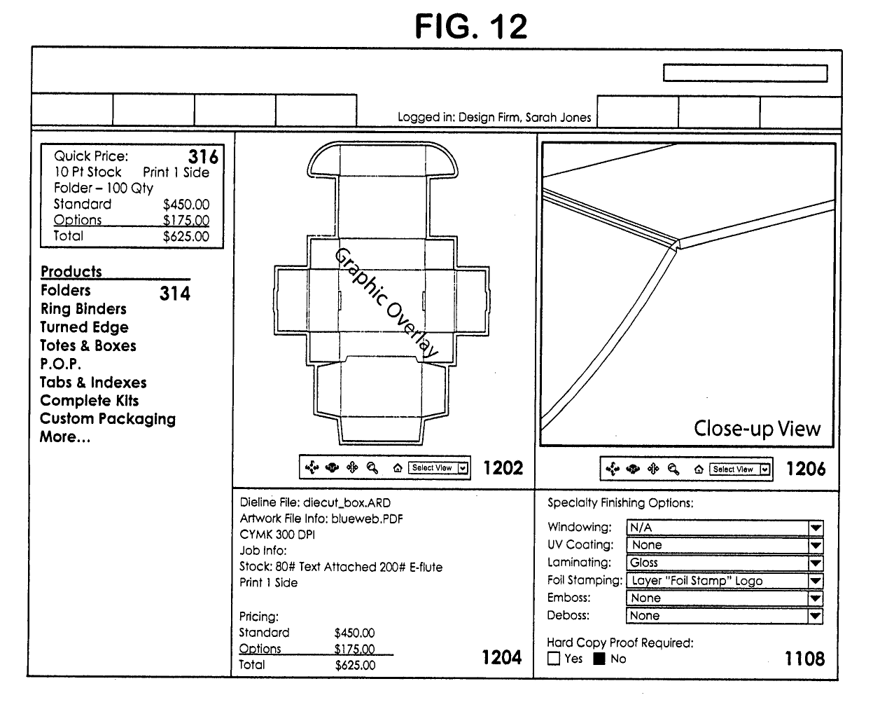

FIG. 12 is another illustration of a proofing page showing different options. Second dieline with art 1202 includes, but is not limited to a 2D layout with viewing options to examine the package in detail. Second job details 1204 gives specifics and options of the job pertaining to the die, artwork, and job. Second 3D proof 1206 can include, for example, but is not limited to a close-up view of the virtual 3D product allowing the user to make decisions in the ordering process to include or not include specialty-finishing options. Viewing options to examine the package in detail including: zoom, rotate, pan, folding sequence, order of assembly, and any other tools necessary to proof the 3D virtual package. Specialty finishing options 1108 can include, for example, options for windowing, UV coating, laminating, foil stamping, embossing, and debossing. This area can include an option for a hard copy proof should one be desired prior to finalizing and producing package. Menu navigation 314 can include, for example, a listing of available web to package printing products for ease navigation to other areas. Quick Price 316 can include, for example a pricing guide for the product selection to this point in the ordering process.

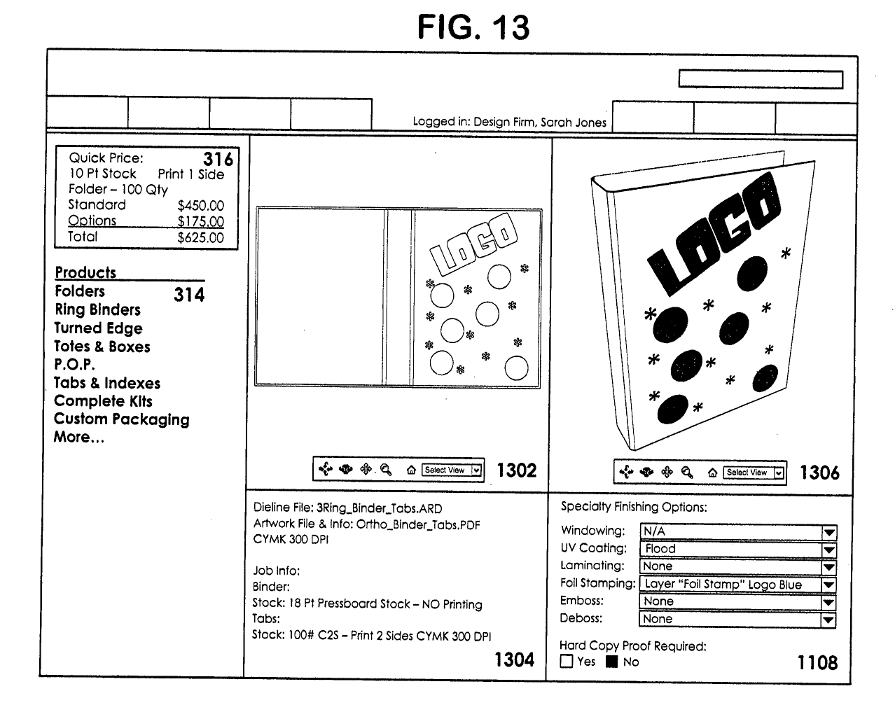

FIG. 13 is an illustration of a proofing page from one of the graphic art templates showing different options. Third dieline with art 1302 includes, but is not limited to a 2D layout with viewing options to examine the package in detail. Third job details 1304 gives specifics of the job pertaining to the die, artwork, and job. Third 3D proof 1306 can include, for example, but is not limited to a close-up view of the virtual 3D product allowing the user to make decisions in the ordering process to include or not include specialty-finishing options available for the graphic art template file. Viewing options to examine the package in detail can include for example: zoom, rotate, pan, folding sequence, order of assembly, and any other tools necessary to proof the 3D virtual package. This virtual 3D proof is updated in real-time showing the options selected in specialty finishing options 1108. Specialty finishing options 1108 can include, for example, options for windowing, UV coating, laminating, foil stamping, embossing, and debossing for the graphic art template file created. This area can include option-for a hard copy proof should one be desired. Menu navigation 314 can include, for example, a listing of available web to package printing products for ease navigation to other areas. Quick price 316 can include, for example a pricing guide for the product selection to this point in the ordering process.

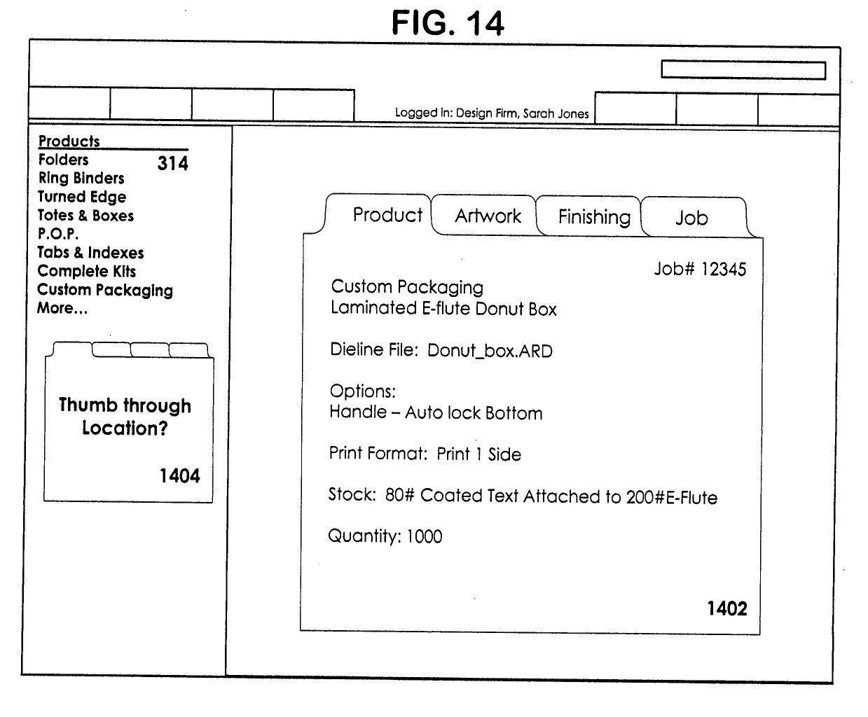

FIG. 14 illustrates an example job overview giving product specifications. Thumb through tabs 1402 can include, for example, job specific categories including but not limited to product, artwork, finishing, and job. Each category will give specifics for example. Product contains specifics about the product being ordered including but not limited to: job number, the dieline file, options selected for the structure, print format, stock, and quantity. Artwork contains specifics about the artwork including but not limited to: job number, artwork file info, compression, fonts used, pictures used, color output, trapping information, and print format. Finishing contains specifics about the specialty finishing options, if any, for the job including but not limited to: Job number, windowing, UV coating, laminating, foil stamping, embossing, and debossing. Job contains specifics about the job including but not limited to job number, the product being ordered, quantity, date of order, hard copy request, scheduled delivery date, delivery method, and quality samples requested. Thumb through tab 1404 is located within a webpage allowing the user to view an overall view of the job including required areas yet to be completed and completed areas with specifics for the job. Menu navigation 314 can include, for example, a listing of available web to package printing products for ease navigation to other areas.

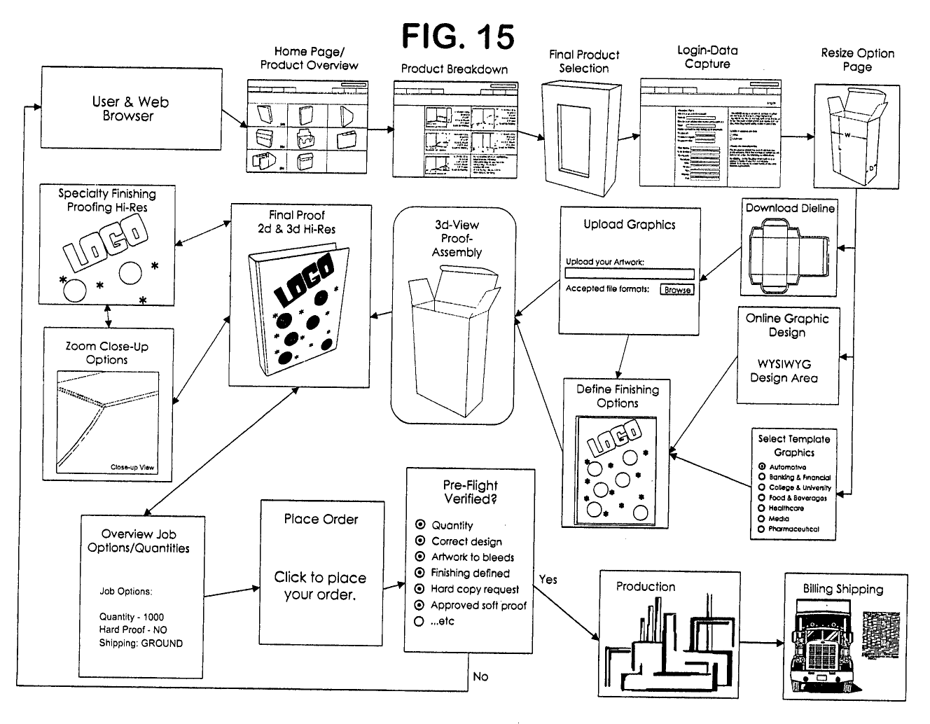

FIG. 15 illustrates a flowchart of the invention. In use, the user selects a package standard from a visual catalog listing of available packaging styles and available options. Existing users “sign-in”. New users provide information necessary to set up an account. If desired, and if resizing options are available for the selected product, the user can be directed to a resizing page to resize the selected package. The user now selects to either download the package standard template (dieline) from the server and creates a graphic design to apply to such template and uploads back to the server, uses a stock graphic design from a library on the site to be applied, or chooses to use an online design area to create graphics online in a “what you see is what you get” environment. For finishing processes needing defined areas the user, who creates their own graphic design and knows of a finishing process they will use can create a ‘layer’ or define an area so called i.e. foil stamp. The graphic is now applied to the package standard and converted into 3D. Once converted into 3D, the product view is updated whenever a change is made or option is selected. The user can now choose from different finishing options. Stock graphic designs and graphics designed online have predetermined finishing options set. Depending on the package and selection of options some finishing techniques will not be selectable depending on current selected options, i.e. if a UV coating is selected then lamination options would not be selectable. Once the user makes their selection of options, a final virtual print quality ‘softproof’ is generated allowing the user to finalize and check the package out with more advanced viewing controls. (Once a view is ‘maxed’ at a current resolution the package is regenerated to the magnification needed to view. This allows color breaks and finishing options to be closely viewed.) Once the final is “approved” the design becomes a job and all appropriate files are generated. The user gets an overview of the job and final cost. The user pays in accordance with applicable payment terms.

The advantages of having a complete web to package printing workflow as disclosed herein are numerous, including but not limited to: eliminating the need to wait for a hard copy to be produced before final decisions are made to the package printing; speeding up the delivery time of the final product; providing tools not currently available from a web interface; providing the user with a complete preproduction workflow all based within a web browser; providing the use with access to all tools needed to order a printed package and eliminating the need to own extensive hardware and software; streamlining and eliminating time-consuming steps currently in use; and allowing the user to see what the final package design will look like without having to actually print, foil stamp, film laminate, diecut, and the like.

Having now described embodiments of the invention, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention and any equivalent thereto. It can be appreciated that variations to the present invention would be readily apparent to those skilled in the art, and the present invention is intended to include those alternatives. Further, since numerous modifications will readily occur to those skilled in the art, it is not desired to limit the invention to the exact construction and operation illustrated and described, and accordingly, all suitable modifications and equivalents may be resorted to, falling within the scope of the invention.

What is claimed is:

1. A web to package printing system comprising:
a web site, said web site further comprising:
a menu navigation tool, wherein said menu navigation tool allows a user to navigate said web site;
a listing of available products, said listing further comprising at least one of:
product breakdown specifications for each available product, or resizing options for each available product;
a selecting tool, wherein said selecting tool allows a user to select at least one product, and select product breakdown specifications;
a means for applying graphic art to said selected product(s);
a proofing page, said proofing page providing at least one of two-dimensional view(s), three-dimensional view(s), viewing options, or finishing options.

2. The web to package printing system of claim. 1, said means for applying graphic art further comprising as least one of:
a graphic library;
a dieline download; or
an on-site graphic design area.

3. The web to package printing system of claim 1, said viewing options comprising at least one of zoom, rotate, folding sequence, or order of assembly.

4. The web to package printing system of claim 1, said three-dimensional view(s) comprising a virtual 3-D product updated in real-time.

5. The web to package printing system of claim 2, further comprising:
a quick price tool, wherein said quick price tool provides the cost of the selected product(s).

6. The web to package printing system of claim 1, further comprising:
an artwork upload processing page.

7. The web to package printing system of claim 1, said finishing options comprising at least one of: windowing, ultra-violet coating, laminating, foil stamping, embossing, or debossing.

8. A web-based method of package design comprising:
selecting a product from a web-based listing of available products;
incorporating design on selected product;
selecting finishing options;
generating a soft-proof wherein said soft-proof incorporates design and finishing options within said selected product; and
reviewing said soft-proof.

9. The method of claim 8 wherein the product is selected from the group of products consisting of folder(s), container(s), grouped product(s), binder(s), point of purchase(s), promotional package(s), turned edge product(s), and tabs and indexes.

10. The method of claim 8, wherein said selection is made from a web-based visual catalog of available products and options.

11. The method of claim 8, further comprising:
resizing selected package.

12. The method of claim 8, said incorporating design on selected package further comprising at least one of:
(a) downloading package standard template from a server, creating a graphic design off-line to apply to said template, and uploading said design back to said server;
(b) using a stock graphic design selected from a graphics library of stock graphic designs; or
(c) creating a graphic design for use on-line.

13. The method of claim 8, wherein said soft-proof updates in real time.

14. The method of claim 8, reviewing said soft-proof further comprising: utilizing viewing options, said viewing options comprising at least one of: zoom, rotate, folding sequence, or order of assembly.

15. The method of claim 8, said finishing options comprising at least one of: windowing, ultra-violet coating, laminating, foil stamping, embossing, or debossing.

16. A package designed by the method of claim 8.
